(19) United States
(12) Patent Application Publication
(10) Pub. No.: US 2015/0366393 A1
(43) Pub. Date: Dec. 24, 2015

(54) Cooking Appliance

(71) Applicant: SUNBEAM PRODUCTS, INC., Boca Raton, FL (US)

(72) Inventors: Peter Fareham, West Didsbury (GB); Stewart Gordon, Huddersfield (GB)

(73) Assignee: SUNBEAM PRODUCTS, INC., Boca Raton, FL (US)

(21) Appl. No.: 14/766,263

(22) PCT Filed: Apr. 5, 2013
(86) PCT No.: PCT/IB2013/052741

§ 371 Date: Aug. 6, 2015

Related U.S. Application Data
(60) Provisional application No. 61/771,275, filed on Mar. 1, 2013.

(51) Int. Cl. A47J 27/00; A47J 37/10

(52) U.S. Cl. CPC A47J 27/002; A47J 37/10

(57) ABSTRACT

A cooking appliance comprises a base, a housing pivotally mounted to the base and a lid pivotally attached to the housing forming a cooking chamber when the lid is in the dosed position. A heating means and a blower means are provided for generating a cooking airflow, A latching pivoting means pivotally connects the housing to the base and is configured to allow the housing to be pivoted from a locked horizontal position to one or more angular positions offset from the horizontal position and to releasably lock the housing in said angular position. A cooking bowl is removably mounted in the housing and is rotated during cooking by a drive motor, wherein food contents are placed into the cooking bowl and the cooking airflow cooks the food contents during cooking. A projection formed partially in a bottom wall and a sidewall of the cooking bowl is configured to stir the food contents in the cooking bowl when the cooking bowl is rotated during cooking.

### FIELD OF THE INVENTION

The invention relates to cooking, and more particularly, to a cooking appliance designed for frying food.

### BACKGROUND OF THE INVENTION

It is known in the art to cook food with a cooking appliance using fat or cooking oil. Many of such cooking appliances immerse the food to be cooked in a vat of heated oil for a period of time until the food is cooked to a desired level of doneness. However, there are drawbacks to cooking food in this manner including the food absorbing too much unhealthy fat, the fat giving the food an undesirable taste, excess fumes, and costly amounts of fat or cooking oil must be used. As such, there is a need for a cooking appliance that can cook different foods with various amounts of fat or cooking oil, in particular, where the amount of fat or cooking oil is the minimal amount required to coat the food with fat or oil and fry the food.

### SUMMARY OF THE INVENTION

The invention is as defined in claim 1 with optional features presented in the dependent claims.

In an embodiment, a cooking appliance is provided which may include a housing and a lid pivotally mounted on the housing so that when the lid is in the closed position an internal cooking chamber is formed. Mounted in the cooking chamber is a removable cooking and stirring bowl that is rotated during cooking by an electric drive motor disposed in the housing. The housing is pivotally mounted on a base portion via a latching pivoting means. The latching pivoting means may include a knob that is operable (e.g. pulled) to release the housing from a horizontal or storage position to one of several pre-determined angular positions in which the housing is rotated relative to the base portion when it is desired to cook selected food contents.

The cooking and stirring bowl may be generally circular-shaped and may include a protruding boss in the center for mounting on a spindle of the drive motor disposed in the housing. The cooking and stirring bowl may be mounted on the spindle such that it is at a fixed angle (greater than zero), for example, between 0° and 20°, preferably between 5° and 15° and most preferably of approximately 10°, from the horizontal when the housing is in the horizontal or storage position. As such, the working angle of the cooking and stirring bowl is the sum of the fixed angle, for example of approximately 10°, plus the angle the housing is tilted to and locked into position via the latching pivoting means. In practice, the angles may be determined by balancing the desire to induce a good tumbling or stirring action with an optimal capacity for retaining foodstuff in the bowl. A single truncated cylinder-shaped projection or hump may be formed partially in the bottom wall of the cooking and stirring bowl and may extend onto the sidewall of the bowl to facilitate stirring and coating the food contents in the bowl with a coating of fat or oil.

In another aspect, a cooking appliance is provided including a base, a housing pivotally mounted to the base, a lid pivotally attached to the housing forming a cooking chamber when the lid is in the closed position, a heating means and blower means disposed in the lid for generating a cooking airflow, a drive motor disposed in the housing, a latching pivoting means pivotally connecting the housing to the base, wherein the latching pivoting means is configured to allow the housing to be pivoted from a locked horizontal position to one or more (e.g. various selectable) angular positions offset from the horizontal position and releasably locking the housing in said angular position, a cooking bowl removably mounted in the housing and which is rotated during cooking by the drive motor, wherein food contents are placed into the cooking bowl and the cooking airflow cooks the food contents during cooking, and a projection formed partially in a bottom wall and a sidewall of the cooking bowl configured to stir the food contents in the cooking bowl when the cooking bowl is rotated during cooking.

The housing may be pivotally connected to the base at or towards a lowermost region of the housing, when in use. This aids stability of the appliance when the housing is angled with respect to the base and ensures that the centre of gravity of the appliance remains low. In particular embodiments, the housing may be pivotally connected to the base at a height that is below the height of the cooking bowl (e.g. below the bottom wall), when the housing is in the horizontal position. In addition, the housing may be pivotally connected to the base at or towards a front region of the housing, when in use. This allows the base to have a height which is lower than would be required to accommodate the tilt of the housing if the pivot was in the centre of the appliance and also ensures that the control panel is angled towards the user, when in use. In particular embodiments, the housing may be pivotally connected to the base approximately half-way between the centre and the front of the housing.

### BRIEF DESCRIPTION OF THE DRAWINGS

A more complete understanding of embodiments of the present invention, and the attendant advantages and features thereof, will be more readily understood by reference to the following detailed description when considered in conjunction with the accompanying drawings wherein:

FIG. 1 is side view of a cooking appliance according to an embodiment of the present invention, in a tilted position.

FIG. 2 is perspective view of the cooking appliance of FIG. 1;

FIG. 2A is a cross-sectional view taken through the centre of the appliance, as illustrated in FIGS. 1 and 2, when the housing in the horizontal position;

FIG. 3 is a perspective view of the base of the cooking appliance of FIG. 1;

FIGS. 4-9 are various views of a cooking and stirring bowl for the cooking appliance of FIG. 1; More specifically, FIG. 4 is a top perspective view of the cooking and stirring bowl for the cooking appliance of FIG. 1;

FIG. 5 is a top plan view of the cooking and stirring bowl of FIG. 4;

FIG. 6 is a side perspective plan view of the cooking and stirring bowl of FIG. 4;

FIG. 7 is a side view of the cooking and stirring bowl of FIG. 4 looking towards an indentation formed by the inner projection in the base and sidewall of the bowl;

FIG. 8 is a side view of the cooking and stirring bowl of FIG. 4, taken after the bowl of FIG. 7 has been rotated anticlockwise by 90 degrees;

FIG. 9 is a side view of the cooking and stirring bowl of FIG. 4, taken after the bowl of FIG. 8 has been rotated anticlockwise by another 90 degrees;

FIG. 10 is a cross-sectional view of the cooking and stirring bowl of FIGS. 4-9, taken along line A-A of FIG. 5, when mounted on the bowl drive mechanism; and

FIG. 11 is a perspective view of the cooking and stirring bowl of FIGS. 4-9 when mounted on the bowl drive mechanism.

### DETAILED DESCRIPTION OF THE INVENTION

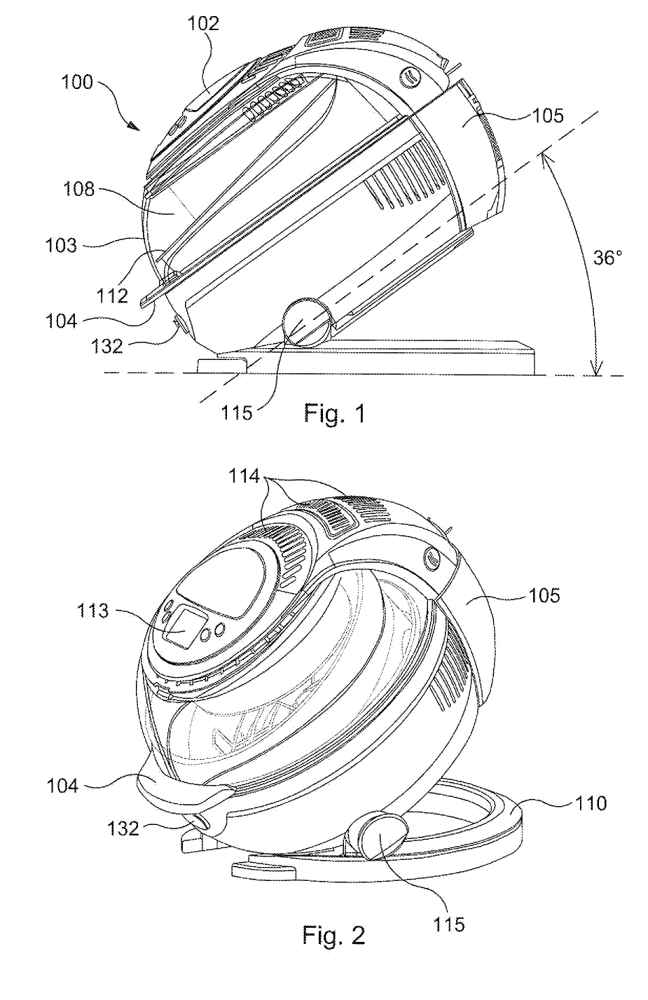

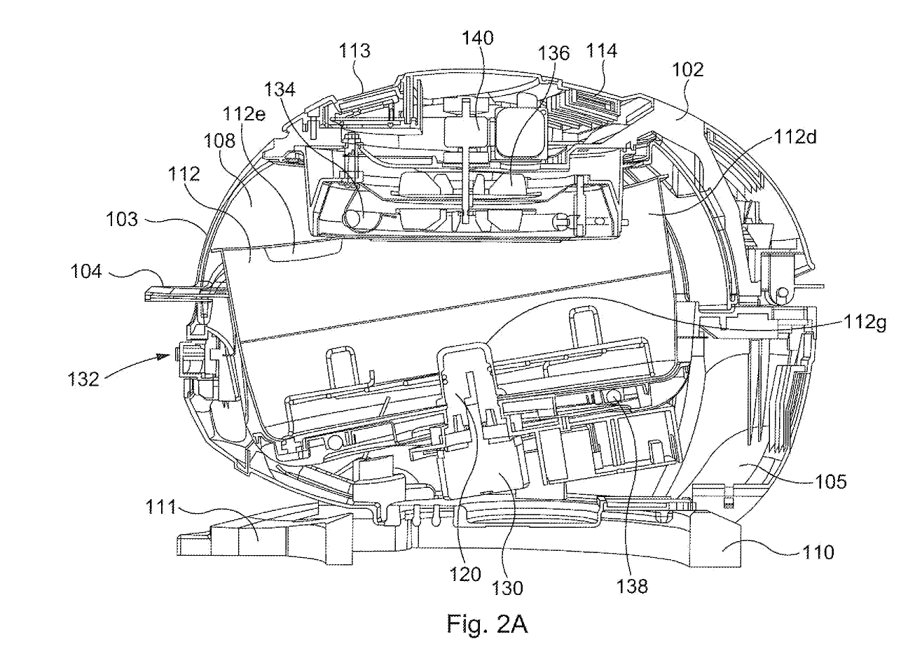

Referring now to the drawing figures in which like reference designators refer to like elements, there is illustrated in FIGS. 1-2A an embodiment of a cooking appliance 100 similar to a cooking appliance disclosed in Chinese Utility Model Patent Application No. ZL 201120326254.4 filed on Sep. 1, 2011 (Chinese Publication No. 202234714 published May 30, 2012), which is incorporated by reference as if fully rewritten herein. The utility model is directed towards a rotary multifunctional cooker comprising a cooker body, cover and heater. The body is provided with an inclined rotary basin and heat flow ducting is provided to circulate heated air over the food in the basin. The basin is inclined at a fixed angle of greater than 15 degrees to the horizontal and a blocking element is provided in a sidewall of the basin. However, the angle of tilt of the basin is not adjustable.

The cooking appliance 100, according to an embodiment of the present invention, includes a housing 105 and a lid 102 pivotally mounted on the housing 105 so that when the lid 102 is in the closed position as illustrated in FIG. 1 an internal cooking chamber 108 is formed. The housing 106 has a larger, generally circular front section and a smaller rectangular section projecting from the rear of the front section along a central axis. The lid 102 is hinged to the housing 105 towards the rear of the rectangular section.

Mounted in the cooking chamber 108 is a removable cooking and stirring bowl 112 that is rotated during cooking by an electric drive motor 130 disposed in the housing 105. The lid 102 includes a transparent portion 103 which allows the interior of the cooking chamber 108 and the contents in the cooking and stirring bowl 112 to be visible from the exterior of the cooking appliance 100. The lid 102 also includes a lip 104 for allowing the lid 102 to be grasped and rotated into the open position (not shown) and a catch/release security mechanism 132 for locking the lid 102 in the closed position.

In this embodiment. a heating means in form of a heating element 134 (which, in this case, is circular) and a blower means in the form of a fan 136 are mounted in the lid 102 for generating a heating airflow that is directed towards the food contents in the cooking and stirring bowl 112 as it is rotated for cooking the food contents. In addition, the cooking and stirring bowl 112 is heated by a further heating means in the form of a heating element 138 (which, in this case, is circular) disposed in the housing 105 for cooking the food contents. In other embodiments, the cooking and stirring bowl 112 may be heated by a one or other of a heating means 134, 138 and blower means 134 disposed in the lid 102 or in the housing 105. The heating means 134, 138 mounted in the lid 102 and/or the housing 105 may be halogen lights, infrared, electrical resistance elements/coils, induction heating or any other heating means known to one of ordinary skill in the art. The blower means may comprise more fans 136, each of which is driven by a motor 140 and configured to draw air passed the heating means 134 and direct it into the bowl 112 to heat the foodstuffs therein. Vents 114 are provided in the lid 102 to allow air to flow into and out of the cooking chamber 108 and/or to cool the motor 140 for the blower means 136.

In the embodiment of FIGS. 1-2, an electronic control panel 113 is mounted on the lid 102 for controlling the heating means 134, 138 disposed in the lid 102 and in the housing 105, the blower means 136 mounted in the lid 102, and the electric drive motor 130 disposed in the housing 105. An electrical power cord (not shown) is connected to a conventional source of electrical power (for example, 120 or 240V ac) for providing electrical power to the control panel 113 and the other electrical components as described above. The control panel 113 includes buttons to selectively increase or decrease the heat or power output of the heating means 134, 138, within the limits defined by the maximum and minimum outputs of the heating means 134, 138. The control panel 113 also includes a cooking timer function to allow the appliance 100 to be powered down after a user-defined cooking period. Alternatively or in addition there may be controls enabling the operation of automatic cooking programs, which may, for example, set and adjust the angle of the housing and/or bowl, the temperature, cooking time, operation of the fan and speed and direction of rotation of the bowl.

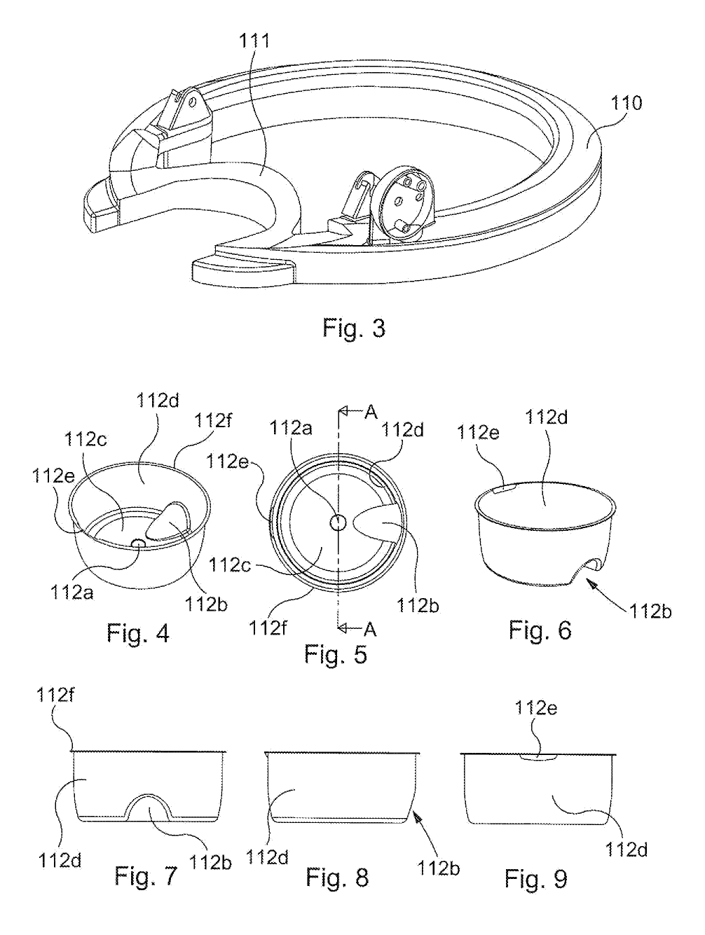

In this embodiment, the housing 105 is pivotally mounted on a part-circular annular base portion 110 (see also FIG. 3) via a latching pivoting means 115. The base portion 110 includes an inverted arc 111 to accommodate the lowermost portion of the housing 105 when it is tilted relative to the base 110. However, in other embodiments, the base may be of a different shape. Preferably the base includes a cutout to accommodate the lowermost portion of the housing 105 when it is tilted relative to the base 110 since this lowers the centre of gravity of the appliance and works in conjunction with the location of the latching pivoting means 115 to provide a stable device.

The latching pivoting means 115 is of a type known in the art and includes a knob that is pulled to release the housing 105 from a horizontal or storage position so it can be manually (or automatically e.g. by a spring mechanism) pivoted to one of several pre-determined angular positions in which the housing 105 is rotated when it is desired to cook selected food contents. For example, the pre-determined angular positions may be 10°, 15°, 25°, 35°, 45° etc. but these examples are not meant to be limiting. Once the housing 105 is rotated to one of the pre-determined angular positions, the knob is released and the housing 105 is locked into the desired angular position. The knob may again be pulled and released to unlock the housing 105 and allow it to return by gravity (or by a manual force) to the horizontal or storage position. A damping mechanism may be provided to allow the housing 105 to return to the horizontal/storage position gently and in order to reduce the risk of damage to the appliance or spillage of the foodstuffs therein.

Note that the disclosed arrangement of the housing 105 containing the rotating cooking and stirring bowl 112 mounted on the base portion 110 via the latching pivoting means 115 is not meant to be limiting in any sense. There may be other means by which the rotating cooking and stirring bowl 112 contained in the housing 105 may be tilted at an angle relative to the horizontal. Alternately, the cooking and stirring bowl 112 or the housing 105 may be fixed at an angle relative to the horizontal including but not limited to 0°, 10°, 25°, 35° and 45°.

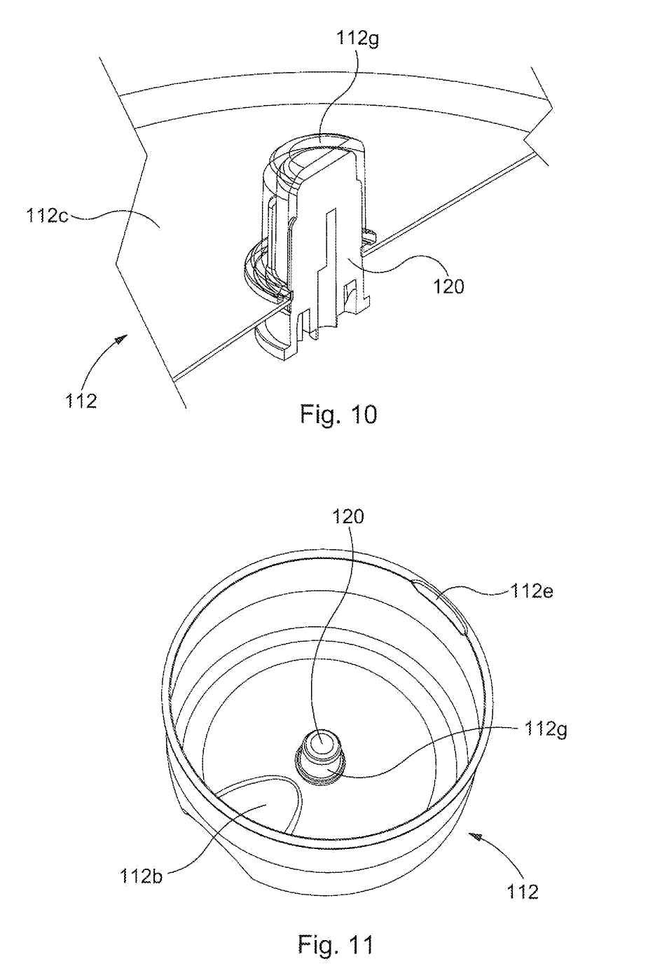

Referring now also to FIGS. 10 and 11, the cooking and stirring bowl 112 is mounted on the spindle 120 of the motor 130 disposed in the housing 105 such that the cooking and stirring bowl 112 is at a fixed angle of approximately 10° from the horizontal when the housing 105 is in the horizontal or storage position. As such, the working angle of the cooking and stirring bowl 112 is the sum of the fixed angle of approximately 10° plus the angle the housing 105 is tilted to and locked into position via the latching pivoting means 115. The housing 105 may be rotated about the latching pivoting means 115 a maximum of approximately 45-46° to give a maximum working angle of around 55°. There may be additional working positions between the maximum tilt angle and the horizontal storage positions which are selected based on the food contents to be cooked. For example, as illustrated in FIG. 1, the cooking and stirring bowl 112 is at an angle of 10° with respect to the housing 105 and the housing 105 is at an angle of 36° from the horizontal to give a working angle of 46′. The purpose of the working tilt angles is discussed in further detail hereinbelow.

In another embodiment, the cooking and stirring bowl 112 is mounted on the spindle 120 of the motor 130 disposed in the housing 105 such that the cooking and stirring bowl 112 is at a fixed angle of approximately 0° from the horizontal when the housing 105 is in the horizontal or storage position. As such, the working angle of the cooking and stirring bowl 112 is equal to the angle the housing 105 is tilted to and locked into position via the latching pivoting means 115. In all embodiments, a removable handle (not shown) may be provided to remove the bowl 112 from the housing 105.

Referring now to FIGS. 4-9, there is illustrated an embodiment of a cooking and stirring bowl 112 for the cooking appliance 100 described above. The cooking and stirring bowl 112 is generally circular-shaped and includes a circular hole 112a for a protruding boss 112g in the center for mounting on the spindle 120 of the drive motor 130 disposed in the housing 105. A single truncated cylinder-shaped projection or hump 112b is formed partially in the flat bottom wall 112c of the bowl 112 and extends onto the vertical sidewall 112d of the bowl 112 for the purposes described hereinbelow. As illustrated in FIGS. 6-8, the hump 112b is formed by a hollow moulding. However, in other embodiments, the hump 112b may be formed by a solid or hollow component which is affixed to the bowl 112. The radius of the arc of the hump 112b may be 35 (thirty-five) millimeters. In other embodiments, the hump 112b may have a radius of 25 mm. The shape of the hump 112b and the radius of its arc were derived by experimentation but not meant to be limiting as there may be other shapes and radii that may also provide satisfactory results. For example, the hump 112a may have a v-shaped, rectangular, trapezoidal or rhomboid cross-section. In addition, in other embodiments there may be more than one hump 112b such as two humps 112b, three humps 112b, etc., spaced apart on the bottom wall 112c/sidewall 112d of the cooking bowl 112. The cooking bowl 112 also includes a cut-out, lip or chute 112e formed in a rim 112f ringing the periphery of the sidewall 112d for directing food contents from within the cooking bowl 112 during emptying. The cutout 112e is provided opposite the projection 112b and guides food back into centre of the bowl 112 as it rotates so as to avoid food getting stuck against the lid 103 when the housing 105 is tilted relative to the base 110.

In use, the bowl 112 is tilted so that the food contents will be stirred and be coated with oil with a minimal amount of fat or cooking oil. If the bowl 112 was not tilted and merely rotated, the food contents would not be stirred and tumble nor be effectively coated with the fat or oil. This may be desirable for certain food items that do not need to be tumbled like larger pieces of meat or vegetables. For other food items such as frozen chips where it is desirable to stir and tumble the food contents in the bowl 112 to thoroughly coat them with fat or oil, the bowl 112 is tilted at a pre-determined working angle. Still, the tilted rotating bowl 112 may not completely stir and tumble the food contents and coat them with the fat or oil. In a fact, the food contents tend to accumulate at the lower end of the rotating bowl 112.

To solve this problem, the hump 112b is provided to prevent food from accumulating at the bottom of the tilted bowl 112 during cooking. As the tilted bowl 112 is rotated during cooking, the food contents that accumulate at the lower most portion of the rotating bowl 112 because of gravity are trapped by the hump 112b and caused to be rotated towards the higher most portion of the bowl 112. The food contents remain trapped until the hump 112a is at the highest most portion of the bowl 112 rotation. Due to the shape of the hump 112a, the food contents are released and caused to tumble back to the lower most portion of the bowl 112. As the bowl 112 is rotated for even cooking of the food, the food contents tumble and are stirred with the other food content pieces and the fat or oil that was initially introduced into the bowl 112 before cooking commenced. As this cycle continues during cooking, the food contents are rotated and effectively stirred and coated with a minimal amount of oil to cook the food contents. This eliminates the need for cooking appliances that need large amounts of fat or oil to immerse the food contents for cooking.

In embodiments of the invention, the cooking appliance 100 may be configured as a low-oil fryer (sometimes referred to as a dry fryer).

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope of the invention, which is limited only by the following claims.

1. A cooking appliance, comprising:
a base;
a housing pivotally mounted to the base;
a lid pivotally attached to the housing forming a cooking chamber when the lid is in the closed position;
a heating means and a blower means for generating a cooking airflow;
a drive motor disposed in the housing;
a latching pivoting means pivotally connecting the housing to the base_{;} wherein the latching pivoting means is configured to allow the housing to be pivoted from a locked horizontal position to one or more angular positions offset from the horizontal position and releasabiy locking the housing in said angular position;
a cooking bowl removably mounted in the housing and which is rotated during cooking by the drive motor, wherein food contents are placed into the cooking bowl and the cooking airflow cooks the food contents during cooking;
and a projection formed partially in a bottom wall and a sidewall of the cooking bowl configured to stir the food contents in the cooking bowl when the cooking bowl is rotated during cooking.

2. The cooking appliance according to claim 1 wherein the cooking bowl is mounted in the housing such that it is at a non-zero fixed angle from the horizontal when the housing is in the horizontal position.

3. The cooking appliance according to either preceding claim wherein the housing is pivotally connected to the base at or towards a lowermost region of the housing, when in use.

4. The cooking appliance according to any preceding claim wherein the housing is pivotally connected to the base at or towards a front region of the housing, when in use.

5. The cooking appliance according to any preceding claim wherein the base includes a cutout to accommodate a lowermost portion of the housing when it is tilted relative to the base.

6. The cooking appliance according to any preceding claim wherein a damping mechanism is provided to allow the housing to return to the horizontal position in a controlled manner.

7. The cooking appliance according to any preceding claim wherein the latching pivoting means comprises a knob operable to release the housing from the horizontal position so that the housing can be rotated relative to the base and locked at said angular position.

8. The cooking appliance according to any preceding claim wherein the cooking bowl has a protruding boss in its center for mounting on a spindle of the drive motor.

9. The cooking appliance according to any preceding claim wherein the cooking bowl is mounted at an angle of between 5° and 15° from the horizontal when the housing is in the horizontal position.

10. The cooking appliance according to any preceding claim wherein the cooking bowl is mounted at an angle of approximately 10° from the horizontal when the housing is in the horizontal position.

11. The cooking appliance according to any preceding claim wherein the projection comprises a truncated cylinder-shaped hump or a hump having a v-shaped, rectangular, trapezoidal or rhomboid cross-section.

12. The cooking appliance according to any preceding claim comprising a plurality of projections spaced apart around the bottom wall and sidewall of the cooking bowl.

13. The cooking appliance according to any preceding claim wherein the cooking bowl is generally circular-shaped.

14. The cooking appliance according to any preceding claim wherein the heating means and/or the blower means are disposed in the lid.

15. The cooking appliance according to any preceding claim wherein the heating means comprises a heating element disposed in the housing.

16. The cooking appliance according to any preceding claim wherein the one or more angular positions may comprise one or more of 10°, 15°, 25°, 35° or 45°.

17. The cooking appliance according to any preceding claim wherein the cooking bowl comprises a cutout formed in a rim of the sidewall for directing food contents within the cooking bowl.

18. The cooking appliance according to any preceding claim configured as a low-oil fryer.

19. A cooking appliance substantially as described herein with reference to the accompanying drawings.
